(19) United States
(12) Patent Application Publication
(10) Pub. No.: US 2026/0318476 A1
(43) Pub. Date: Oct. 15, 2026

(54) Versatile Hanging Device for Securely Suspending a Variety of Articles and a System thereof

(71) Applicants: William Sieburg, Lewisburg, TN (US); David Sieburg, Lewisburg, TN (US)

(72) Inventors: William Sieburg, Lewisburg, TN (US); David Sieburg, Lewisburg, TN (US)

(21) Appl. No.: 19/177,203

(22) Filed: Apr. 11, 2025

(51) Int. Cl. F16M 13/02

(52) U.S. Cl. CPC F16M 13/022

(57) ABSTRACT

The present invention relates to a multidirectional hanging system configured for securely suspending articles in various environments. The system includes two clamping arms with a spring-loaded mechanism. The system ensures a firm, stable grip on the article while maintaining constant tension for secure attachment. The suspension portion of clip is equipped with reinforced hanging elements such as semi-circular or U-shaped hooks to allow the system to easily suspend from a variety of supports. The multi-directional capability enhances the system adaptability, making it suitable for a wide range of applications from retail displays and industrial workshops to home storage solutions. The system interlocking mechanism provides a reliable, pressure-driven hold, ensuring that the item stays securely in place. The reinforced suspension elements enhance the system load-bearing capacity, enabling it to hold heavier items without compromise. The invention offers an efficient, flexible solution for organizing and suspending items securely across multiple settings.

### TECHNICAL FIELD

The invention relates to a versatile hanging device for securely suspending a variety of articles and a system thereof. More specifically to a multidirectional hanging clip configured to securely suspend items by providing enhanced stability and support. The multidirectional hanging clip improves upon traditional hang clips by offering multi-hanging functionality, ensuring secure attachment for a variety of items and increasing versatility, durability and ease of use in demanding environments. The invention further relates to a clip configured to securely hold at least an article.

### BACKGROUND

The background description includes information that may be useful in understanding the present invention. It is not an admission that any of the information provided herein is prior art or relevant to the presently claimed invention, or that any publication specifically or implicitly referenced is prior art.

Traditionally, hanging systems have been integral tools in a variety of settings that serves a simple yet essential function of holding items in a suspended position. The most common use of the hanging systems was in domestic environments where they were used to attach clothing to clotheslines or drying racks. The hanging system typically spring-loaded and crafted from materials such as wood, plastic or metal were configured to keep garments from blowing away or tangling during the drying process. Similarly, in retail, hanging systems plays a crucial role in displaying clothes where they were used to attach garments to hangers or racks, keeping them neatly organized and easy to access. In industrial and mechanical settings, hanging systems were similarly used to suspend tools, cables, components and other assemblies, keeping them secure and accessible while optimizing workspace organisation.

One key example of such assemblies involves locking clips and their use in connecting various items such as the straps of a backpack or a towel holder. Locking clips are used to secure items together, providing a strong, reliable hold in environments where the integrity of the connection is essential. For instance, in the case of a backpack, locking clips are often used to fasten straps or compartments, preventing them from coming loose during use. Similarly, towels in commercial settings such as gyms or spas may be hung using locking clips to ensure they remain in place. The assemblies rely on the secure attachment provided by the hanging system to keep items firmly suspended and prevent displacement. While the basic structure of hanging systems remained largely unchanged for many years, their effectiveness and utility began to show limitations over time especially as industries and materials evolved.

Despite widespread use of the hanging systems, the traditional hanging systems often faced significant shortcomings particularly in environments requiring a higher degree of gripping and application versatility. One of the major limitations was the lack of a secure locking mechanism. Most traditional systems or device relied on simple spring-loaded systems which were sufficient for holding lighter or less demanding items but, were prone to wear and tear over time. As the system aged or were subjected to repeated use the spring tension would often decrease, leading to a diminished grip specially when gripping. This was particularly problematic not only in industrial and mechanical applications but household usage, where the weight or size of the items being hung increased and a secure hold was critical. In such scenarios, traditional systems were prone to slipping or detaching, posing a safety risk or causing disruptions in operations.

Furthermore, traditional hanging systems lacked versatility. Most were configured as one-size-fit-all solutions, meaning that they were often ineffective when attempting to hold items of varying shapes, sizes and weights. In retail, for example, hanging system were configured for hanging light articles such as garments, might not be able to securely hold heavier items like coats or accessories without the addition of multiple clips. In mechanical or industrial settings, the lack of adoptability made it difficult to adapt hang clips to suit the specific needs of different components, leading to inefficiencies in both time and labour.

Additionally, traditional hanging systems provides limited hanging option. The traditional hanging device or system lacks in multiple side hanging and thus limiting the effectiveness of the hanging device with or without clip in minimizing the risk of item displacement or failure to remain securely in place.

US201702656651 discloses a clip comprising a pair of opposed gripping portions, each having a gripping surface, each gripping portion being located on a clip half, wherein one clip half further includes a stop space apart from the gripping portion which is engageable with a point spaced apart from the gripping portion on the other clip half.

US20090272704A1 discloses a cup rack that contains at least a lower rail suspended by at least two connection members. The connection members affixed to a bottom surface of a shelf or ceiling, or they could be slidably positioned in a pair of parallel upper rails. A number of hook members are hung across the lower rail. The positioning of the hook member is achieved by a bolt running through the hook member and into a block slidably positioned in the lower rail. Depending on how the block is oriented, the hook member could be locked to the lower rail or the hook member could be slid freely along the lower rail.

Conventionally, there exist several hanging systems or device configured with single-side hanging capabilities, capable of handling loads while offering efficient gripping surface.

Further, there is a pressing need for an improved hanging system with versatile usage providing versatile hanging provisions and/or efficient gripping solution. The solution would address the issues of security, durability, versatility and ease of use. The modern demands of various industries from retail to industrial applications required a more adaptable solution that could handle heavier loads, withstand harsh conditions, provide multi-hanging capability and be easily adjustable to accommodate a range of items.

### SUMMARY

The present invention relates to a versatile hanging device and system configured to securely suspend a variety of articles thus, providing an efficient solution for organizing and displaying items. The invention further provides a hanging system with at least a hook for hanging the at least an article. The hanging system ensures that articles remain firmly in place, eliminating the risk of slipping or detachment. The hanging system may be a hanging device, clip etc. The system includes two clamping arms that oppositely placed and pivotally connected to each other. Additionally, the suspension mechanism allows the hanging system to be easily hung from various supports i.e. a wire, a rod, a hanger bar, or another similar structure. Further, the innovative configuration enhances both stability and flexibility, offering a reliable suspension solution for a wide range of applications such as in retail spaces, offices and storage areas. The hanging system secure grip with multi-directional hanging makes it ideal for organizing items, displaying products, and managing personal belongings. The invention is particularly advantageous in settings where secure suspension is crucial. The hanging system is useful for various industries including retail, office organization, manufacturing and home storage. By providing a versatile and reliable solution for managing and displaying items, the clip enhances efficiency and organization, offering both practical benefits and convenience for diverse environments.

In an embodiment of the present invention, the invention discloses a hanging system for securely hanging a variety of articles, the hanging system comprising two clamping arms which includes a first clamping arm and a second clamping arm. Each of the clamping arm extends between a proximal end and a distal end. The two clamping arms are oppositely placed and pivotally connected. In addition, at least one of the two clamping arms comprises a suspension portion configured to a plurality of hanging elements. The plurality of hanging elements is configured to suspend the hanging system from a support. Further, the hanging elements comprises inner notch and cut out for secure hold and preventing slippage from the support. Each of the clamping arms includes a griping portion configured to securely grip the articles.

In one of the embodiments of the present invention, both the clamping arms comprises the suspension portion.

In one of the embodiments of the present invention, the support comprises a wire, a rod, a hanger bar or similar structure for hanging the articles.

In one of the embodiments of the present invention, the plurality of hanging elements comprises a hook element with a semi-circular or U-shaped hanging element to hang the articles at multi-direction with the support. In other embodiment, hanging element may be of other shape adoptable for versatile hanging solutions.

In one of the embodiments of the present invention, the plurality of hanging elements includes a magnet.

In one of the embodiments of the present invention, the hanging element comprises a plurality of curvatures along the hook portion to provide multidirectional hanging with the support.

In one of the embodiments of the present invention, the plurality of the curvatures are further reinforced in the suspension portions to enhance load-bearing capacity and durability of the suspension portion.

In one of the embodiments of the present invention, the griping portion comprises oppositely placed elongated element.

In one of the embodiments of the present invention, an interlocking mechanism is designed to apply pressure and securely hold the article when elongated elements are compressed together.

In one of the embodiments of the present invention, the two clamping arms are oppositely placed and pivotally connected by a spring-loaded mechanism at a central portion, wherein the spring-loaded mechanism is configured to apply tension between the first clamping arm and the second clamping arm to maintain a closed position at a proximal end of the clamping arms.

In one of the embodiments of the present invention, the spring-loaded mechanism comprises pin with rivets and spring assembly configured to provide tension and control, maintaining stability and secure attachment of the clamping arms.

It is within the scope of the invention to include interlocking mechanism in all the embodiments of the clips regardless of whether it is the hanging system or hanging device.

In an embodiment of the present invention, the invention discloses a clip configured to securely hold at least an article. The clip comprises two clamping arms which further includes a first clamping arm and a second clamping arm. Each of the clamping arm extends between a proximal end and a distal end. In addition, the two clamping arms are oppositely placed and pivotally connected. In the embodiment, each of the clamping arms includes a griping portion configured to securely grip the articles. The griping portion comprises oppositely placed elongated element and an interlocking mechanism is designed between the gripping portion to apply pressure and securely hold the article when elongated elements are compressed together.

In an embodiment of the present invention, the invention discloses a multi-directional hanging device for a variety of articles. The multi-directional hanging device comprising a suspension portion configured to a plurality of hanging elements. The plurality of hanging elements is configured to suspend the multi-directional hanging device from a support. In addition, the plurality of hanging elements comprises a semi-circular or U-shaped hanging element. In addition, the plurality of hanging elements includes curvatures aligned for multi directional hanging and enhanced load-bearing capacity.

In one of the embodiments of the present invention, the suspension portion has an attachment.

In one of the embodiments of the present invention, the attachment is configured to include a tool, a hanger, a hook, a clip, condiment container and dispenser, a peel and stick attachment for bars, coffee, a multidirectional cloth hanger, a Velcro strap attachment, book, packaging and any article to be hanged.

In one of the embodiments of the present invention, the attachment is permanent or removable.

In one of the embodiments of the present invention, the support includes a wire, a rod, book organizer, scheduler, a magnetic rod attached for vehicle, kitchen, fridge, a hanger bar or any structure for hanging the articles.

In one of the embodiments of the present invention, the attachment comprises two clamping arms which are oppositely placed and pivotally connected to each other.

In one of the embodiments of the present invention, the pivot comprises the spring-loaded mechanism which includes pin, rivets and spring assembly configured to provide tension and control, maintaining stability and secure attachment of the clamping arms. In other embodiments, it is well within the scope of the invention to provide a pivot with other mechanical configuration to provide tension between the clamping arms.

For further clarification of the features and other embodiments of the invention, a more particular description is provided that will further explain the features and advantage of the invention with the illustration or the drawings. As will be appreciated, other embodiments of the present invention are possible utilizing, alone or in combination, one or more of the features set forth above or described in detail below.

### BRIEF DESCRIPTION OF THE DRAWINGS

A full understanding of the invention can be gained from the following description of the preferred embodiments when read in conjunction with the accompanying drawings in which:

FIG. 1A illustrates a perspective view of a hanging system or device, in according to embodiments of the present invention disclosed herein.

FIG. 1B illustrates a perspective view of a hanging system connected with a suspension portion, in according to embodiments of the present invention disclosed herein.

FIG. 2 illustrates a perspective view of a hanging system configured to securely hold an article, in according to embodiments of the present invention disclosed herein.

FIG. 3 illustrates a perspective view of a hanging element having an inner notch or cut-out for securely holding at least an article, in according to embodiments of the present invention disclosed herein.

FIG. 4 illustrates a perspective view of a multi-directional hanging device having plurality of ridges or curvature along the suspension portion for multidirectional hanging, in according to embodiments of the present invention disclosed herein.

FIG. 5 illustrates a perspective view of a clip configured to suspend from various support structures, in according to embodiments of the present invention disclosed herein.

FIG. 6 illustrates a perspective view of a clip used for home organization, in according to embodiments of the present invention disclosed herein.

FIG. 7A illustrates perspective view of a multidirectional clothes hanger, in according to embodiments of the present invention disclosed herein.

FIG. 7B illustrates perspective view of a multidirectional hook, in according to embodiments of the present invention disclosed herein.

FIG. 7C illustrates perspective view of a tool clip, in according to embodiments of the present invention disclosed herein.

FIG. 7D illustrates perspective view of a Velcro strap attachment, in according to embodiments of the present invention disclosed herein.

FIG. 7E illustrates perspective view of a condiment container and dispenser, in according to embodiments of the present invention disclosed herein.

FIG. 7F illustrates perspective view of a peel and stick attachment for bags, in according to embodiments of the present invention disclosed herein.

FIG. 8A illustrates perspective view of a magnetic rod attachment, in according to embodiments of the present invention disclosed herein.

FIG. 8B illustrates perspective view of a magnetic fridge rod attachment, in according to embodiments of the present invention disclosed herein.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

References will now be made in detail to the presently preferred embodiments of the invention, examples of which are illustrated in the accompanying drawings. Throughout the following detailed description, the same reference numerals refer to the same elements in all figures.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and it is not intended to be limiting the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the following description, reference will be made to the accompanying drawing, in which comparable functional elements are designated with like numerals. The aforementioned accompanying drawings show by way of illustration and not by the way of limitation, specific aspects and implementations consistent with principles of this disclosure. These implementations are described in sufficient detail to enable those skilled in the art to practice the disclosure and it is to be understood that other implementations may be utilized, and that structural changes and/or substitutions of various elements may be made without departing from the scope and spirit of this disclosure. The following detailed description is, therefore, not to be construed in limited sense. It is noted that description herein is not intended as an extensive overview, and as such, concepts may be simplified in the interests of clarity and brevity. All documents mentioned in this application are hereby incorporated by reference in their entirety.

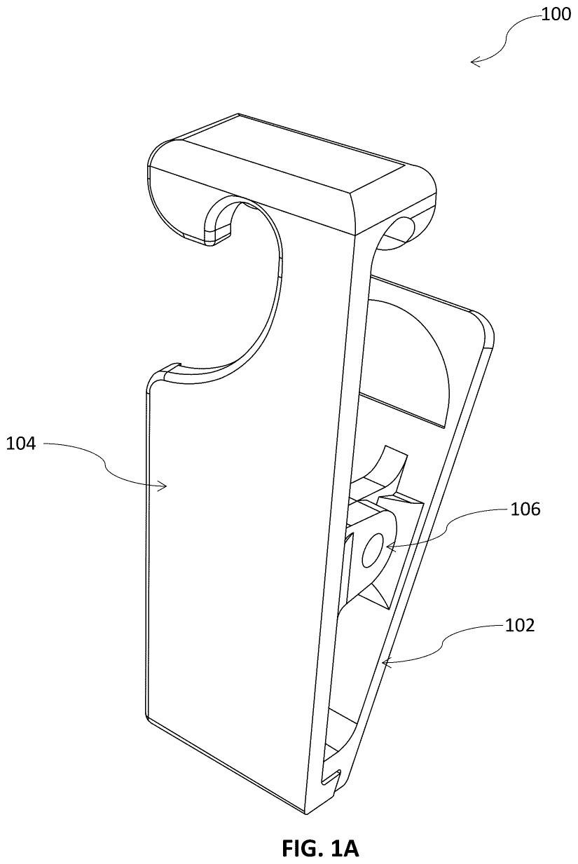

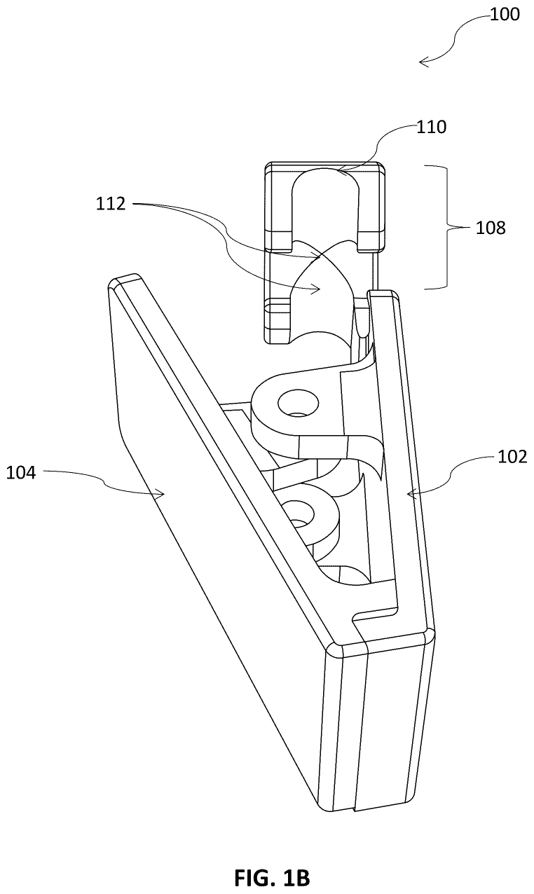

According to the embodiment of the present invention, a hanging system 100 as shown in FIG. 1A-FIG. 1B is configured to securely suspend a variety of articles thus, offering a versatile and reliable solution for both domestic and industrial applications. In the embodiment, according to FIG. 1A, the two clamping arms. i.e. first clamping arm 102 and a second clamping arm 104 are positioned oppositely and are pivotally connected at their central portion 106 via a spring-loaded mechanism which applies constant tension to maintain the closed position of the clamping arms at their proximal ends. The pivotal connection between the clamping arms enables the system 100 to grip and hold items securely in place, making it adaptable to a wide range of hanging needs. In addition, the spring-loaded mechanism comprises pin with rivets and spring assembly configured to provide tension and control thus, maintaining stability and secure attachment of the clamping arms. In the embodiment, according to FIG. 1B, the hanging system 100 includes a suspension portion 108 in at least one of the clamping arms i.e. first clamping arm 102 and second clamping arm 104. The suspension portion 108 is configured to incorporate a plurality of hanging elements, providing the system 100 with multiple points of attachment for securing the hanging system 100 to a support. The support may include but not limited to a wire, rod, hanger bar or any similar structure that can be used to hang the articles. The plurality of hanging elements is integrated into the suspension portion 108, providing flexibility and enhancing the stability of the hanging system. The plurality of hanging elements integrated into the suspension portion 108 can include hook elements 110 configured with semi-circular or U-shaped profiles. The hook elements 110 offer the advantage of multi-directional hanging, enabling the system to suspend articles from the support in different orientations. The hook elements 110 include multiple curvatures or ridges 112 along the hook portion. The curvatures 112 are configured to improve the multi-directional hanging capability, allowing the system 100 to better adapt to various hanging needs. Furthermore, the curvatures 112 are reinforced within the suspension portion 108, enhancing the overall load-bearing capacity and durability of the system. The reinforcement ensures that the system 100 can withstand heavier loads without compromising the performance or safety. Further, the clamping arms i.e. first 102 and second clamping arms 104 includes gripping portion (not shown) for securely gripping the article.

In one of the embodiments of the present invention, the hanging system may incorporate magnets as part of the hanging elements. The magnets offer a non-permanent attachment option, allowing the system to be used in environments where temporary or adjustable hanging solutions are required. The magnets provide a strong and secure hold while also allow for easy repositioning when necessary.

In one of the embodiments of the present invention, the griping portion comprises oppositely placed elongated element.

In one of the embodiments of the present invention, an interlocking mechanism is designed to apply pressure and securely hold the article when elongated elements are compressed together.

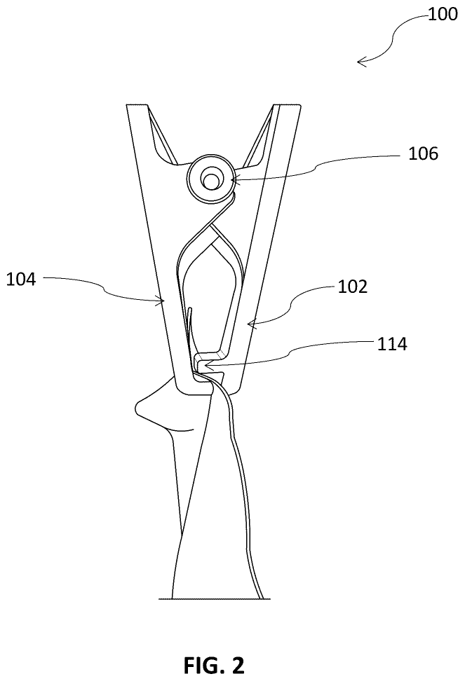

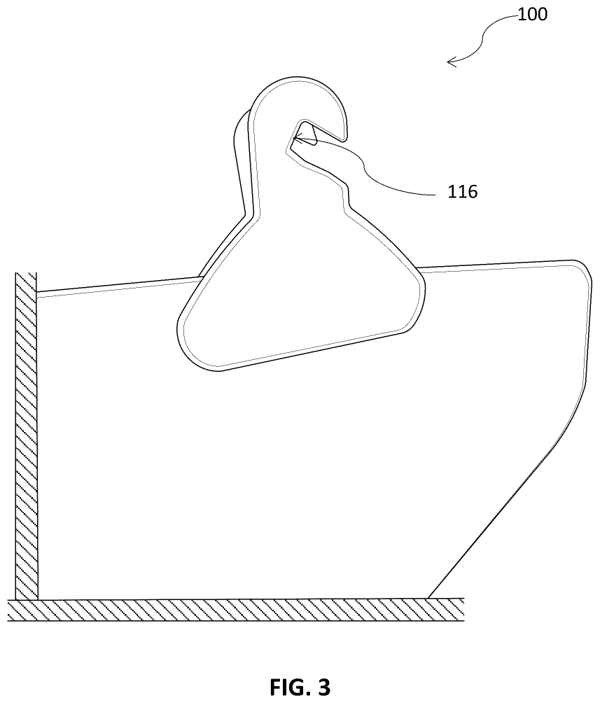

In an embodiment of the present invention, a clip configured to securely hold at least an article is disclosed in FIG. 2. The clip 100 comprises two clamping arms i.e. a first clamping arm 102 and a second clamping arm 104, each configured to extend from a proximal end to a distal end. The clamping arms are positioned oppositely and are pivotally connected at a central point 106, allowing for easy movement and adjustment. The pivotal connection between the arms ensures that the clip can open and close, enabling the user to insert and remove the article being held between the clamping arms. Each clamping arm includes a gripping portion 114 configured to securely grip the article once it is inserted between the arms. The gripping portions 114 of both arms are equipped with oppositely placed elongated elements which provide enhanced contact area and improved grip on the article. The elongated elements are strategically placed to optimize the pressure applied to the article, ensuring a firm hold. When the clip 100 is engaged, the gripping portions 114 of the arms come together and the elongated elements compress, creating a force that firmly secures the article in place. The gripping mechanism is further enhanced by an interlocking mechanism between the elongated elements. As the two elongated elements are pressed together, they interlock in a manner that increases the pressure applied to the article, ensuring that the item is securely held without the risk of slipping or being displaced. The interlocking mechanism is configured to maintain a consistent and reliable grip, even under varying conditions such as temperature fluctuations or slight movements. In the embodiment, according to FIG. 3, the hanging system 100 clip have innovative structural design, the suspension portion may also include inner notches 116 or cutouts within the hanging elements. The structure provides an additional layer of security by preventing the hanging system 100 from slipping off the support, ensuring that the system remains securely attached even in dynamic or challenging environments. The hanging system 100 is particularly beneficial in environments where the system may experience external forces such as wind or vibration, preventing the article from falling or swinging.

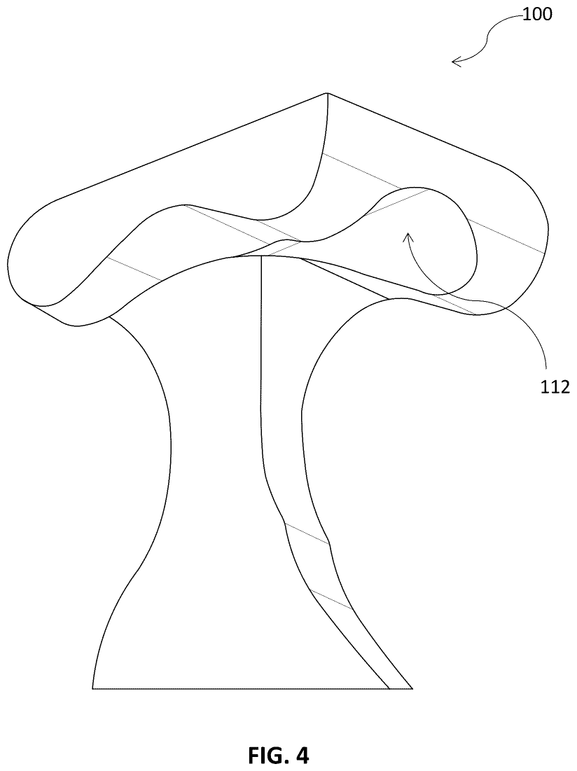

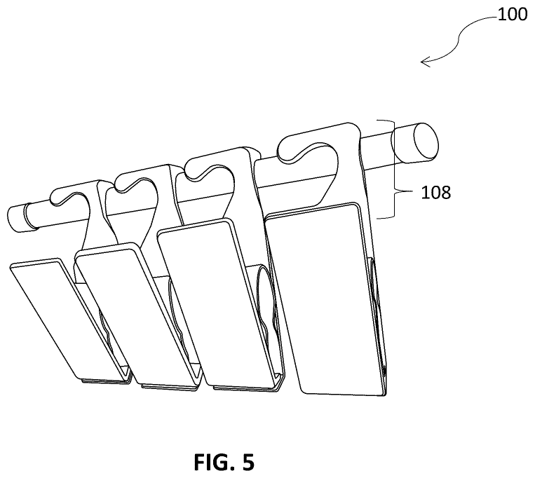

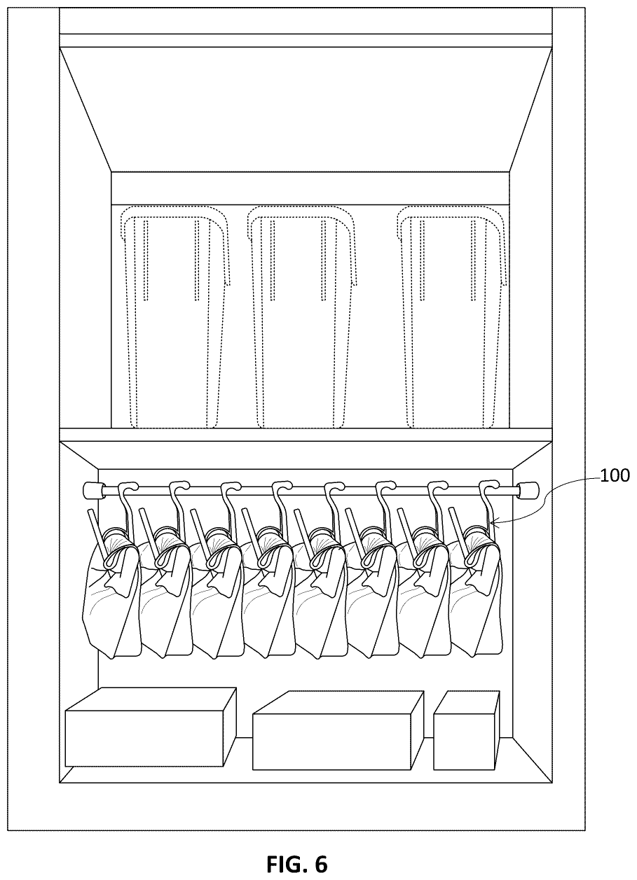

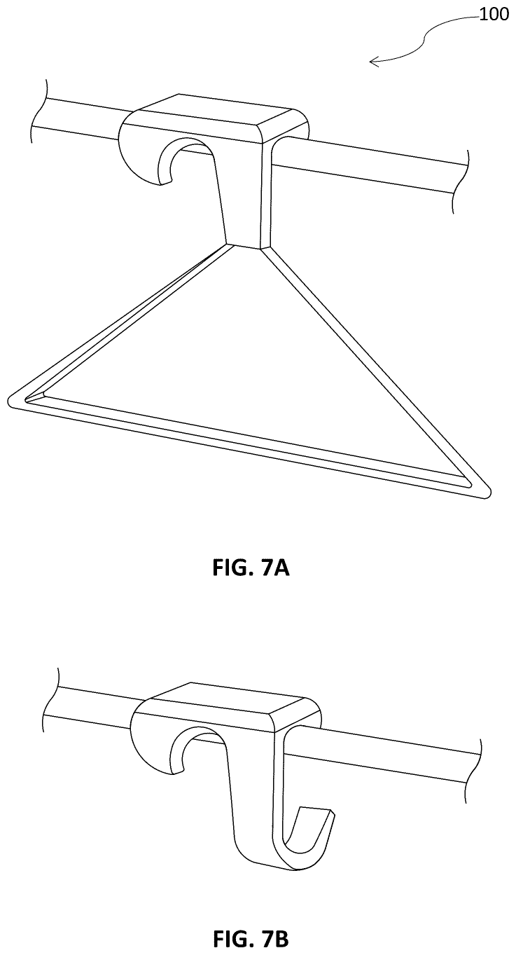

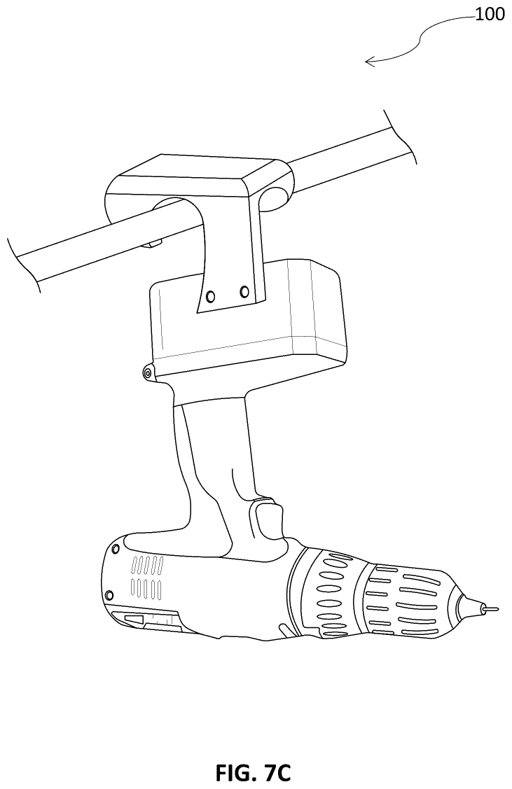

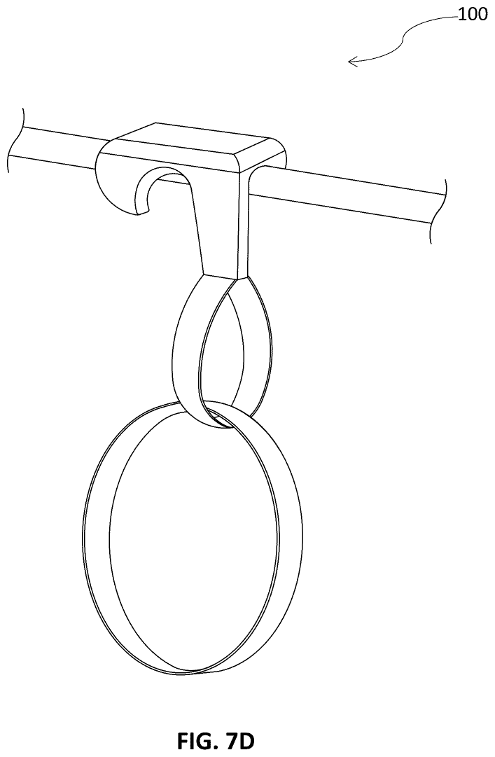

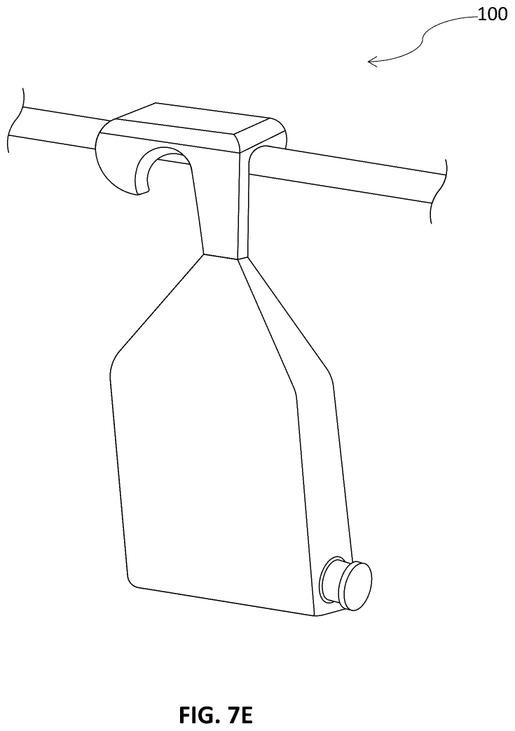

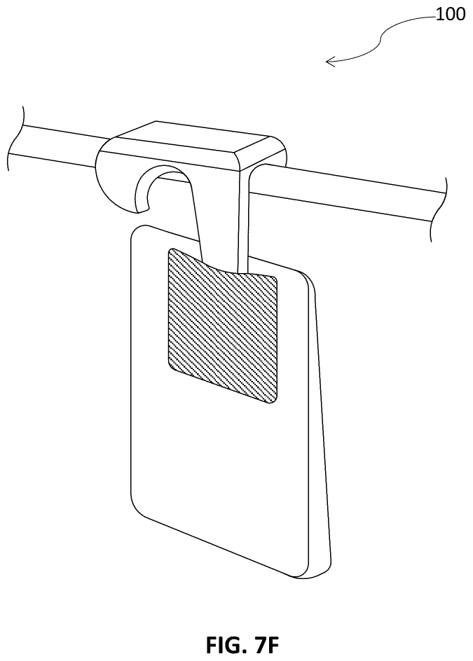

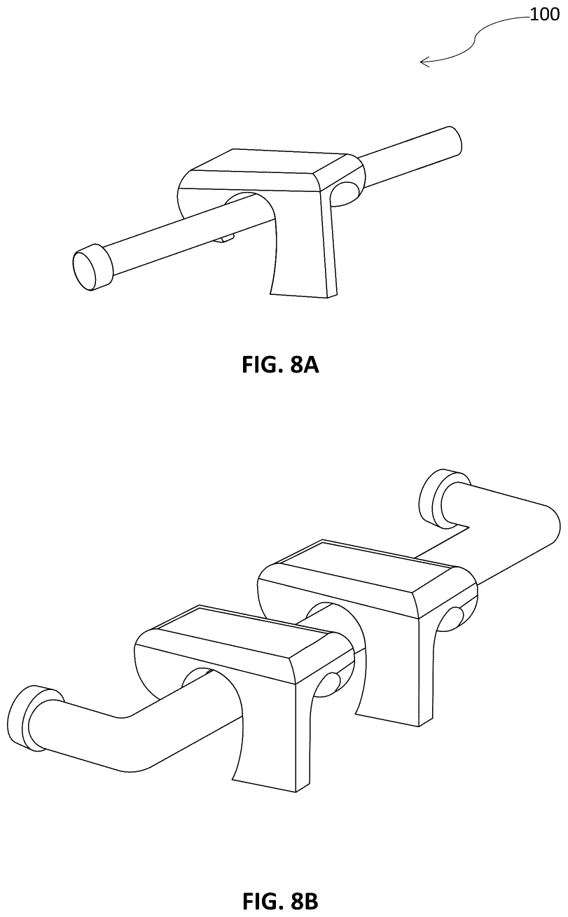

In an embodiment of the present invention, the multi-directional hanging device is configured to securely suspend a variety of articles using a suspension portion with multiple hanging elements as shown in FIG. 4. The elements include semi-circular or U-shaped curvatures, providing load-bearing capacity and allow for multi-directional hanging. The device 100 includes customizable attachments such as hooks, clips, hangers, Velcro straps, or condiment containers which can be permanent or removable. The device 100 is adaptable to different support structures like wires, rods, or magnetic rods for various environments. The ridges and the curvature 112 of the hanging elements provides a functionality to bear heavier loads over time, ensuring that the device remains reliable and stable under stress. In the embodiment, according to FIG. 5, the clip 100 provides a capability to easily and securely hang from a variety of support structures. The suspension portion 108 plays a crucial role in ensuring the clip 100 remains stable and securely attached during use. The portion 108 is equipped with hanging elements which can be easily connected to supports like wires, rods, or similar structures. The suspension portion is configured to accommodate different support configurations, offering flexibility for various applications such as retail, industrial or storage environments. In retail environments, the clip 100 is ideal for displaying items such as clothing, accessories, or merchandise. The ability to hang items both parallelly and perpendicularly from a range of supports like rods, wires or racks which makes them perfect for organizing products in different display arrangements. The rod supports attachment under cabinet or under shelf. Further, the rod support is provided for the clip in case of free-standing rack used in table, counter, desk etc. Retailers can easily adjust the angle or direction of hanging based on space constraints, aesthetics or product visibility needs. Further, in the embodiment, the multidirectional hanging clip as shown in FIG. 6 can be used for home organization. The clip 100 provides an effective solution for managing storage in areas such as garages, closets or utility rooms. In the embodiment, the hanging system 100 as depicted in FIG. 7A is configured to be highly versatile, adapting to a variety of scenarios and applications depending on the needs of the user. The attachment member in the hanging system can be configured to function in several distinct ways. One of the primary configurations of the hanging system 100 is as a hanger. In the application, the system 100 serves as a traditional clothes hanger, allowing users to hang garments such as shirts, jackets, or dresses. The suspension mechanism ensures the clothes are securely held in place, preventing them from slipping or falling off the hanger. This makes it ideal for use in closets, laundry rooms or retail environments where organized and secure hanging is crucial for clothing storage or display. In the embodiment, according to FIG. 7B, the system 100 may be used as a hook. When set up as a hook, the hanging device 100 can be used to hold a variety of items such as bags, coats or even kitchen tools like pots and pans. The secure grip offered by the clamping arms and hanging elements ensures that the hook remains stable, even when subjected to weight or external forces. For example, in kitchens the system 100 could be used to hang cooking utensils or cleaning tools, helping to save space and keep the area organized. In the embodiment, according to FIG. 7C, the system can also function as a tool clip, offering a secure mechanism to attach items such as papers, fabrics or cables or drill bits or drilling machine. In the scenario, the clamping arms act like a traditional spring-loaded clip, providing a firm grip to prevent the items from being displaced. Additionally, according to FIG. 7D, the system can also serve as a Velcro strap attachment allowing users to easily secure the device around items such as bags, bundles, or other equipment. The Velcro configured to ensure that the attachment can be quickly fastened and adjusted, providing a flexible solution for carrying or organizing items. For instance, in a camping scenario, the Velcro strap could be used to secure the hanging system to a tent pole or tree branch, holding items such as tools or bags. In addition, according to FIG. 7E, the system 100 can also be configured as a condiment container and dispenser. By modifying the hanging system to hold small containers or bottles, it can be used in environments like kitchens or restaurants for storing and dispensing condiments such as ketchup, mustard, or sauces. The secure hanging mechanism allows the containers to be easily accessed while ensuring they remain in place when not in use. For instance, in a cafe or food stall the setup would be ideal for holding sauces or napkins while keeping the area neat and accessible. Further, according to FIG. 7F, the system can be adapted to function as a peel-and-stick attachment. In the configuration, the attachment member is configured to stick to surfaces such as bars, counters or coffee tables. The peel-and-stick capability makes it easy to attach the system to various surfaces without the need for permanent fixtures. For example, a coffee shop could use this to attach the hanging system to the edge of a counter to hold items like cups or napkins, providing an efficient and organized display for customers. Moreover, according to FIG. 8A, the hanging system can be equipped with a clip 100 that securely holds items such as kitchen utensils or tools on a magnetic rod. Further, FIG. 8B discloses a magnetic fridge rod attachment with clip, offering a convenient and clutter-free way to organize kitchen essentials without drilling or permanent mounting.

In one of the embodiments of the present invention, the suspension portion has an attachment.

In one of the embodiments of the present invention, the attachment is configured to include a tool; a hanger; a hook; a clip; condiment container and dispenser; a peel and stick attachment for bars, coffee; a multidirectional cloth hanger; a Velcro strap attachment; book; packaging, and any article to be hanged.

In one of the embodiments of the present invention, the support includes a wire, a rod, book organizer, scheduler, a magnetic rod attached for vehicle, kitchen, fridge, a hanger bar or any structure for hanging the articles.

In one of the embodiments of the present invention, the pivot comprises the spring-loaded mechanism comprises pin, rivets and spring assembly configured to provide tension and control, maintaining stability and secure attachment of the clamping arms.

It should be understood that the examples provided herein are intended only for purposes of illustration and any number of other implementations is also contemplated. Additionally, the referenced examples (including the described rules and/or other techniques) can be combined in any number of ways.

Although an overview of the inventive subject matter has been described with reference to specific example implementations, various modifications and changes can be made to those implementations without departing from the broader scopes of implementation of the present disclosure. Such implementation of the inventive subject matter can be referred to herein, individually or collectively, by the term “invention” merely for convenience without intending to voluntarily limit the scope of this application to any single disclosure or inventive concept if more than one is, in fact is disclosed.

The implementations illustrated herein are described in sufficient detail to enable those skilled in the art to practice the teachings disclosed. Other implementations can be used and derived therefrom, such that structural substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources or structures described herein as a single instance. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A hanging system for securely hanging a variety of articles, the hanging system comprising:
two clamping arms comprising a first clamping arm and a second clamping arm;
each of the two clamping arm extends between a proximal end and a distal end;
wherein the two clamping arms are oppositely placed and pivotally connected;
wherein at least one of the two clamping arms comprises:
a suspension portion, the suspension portion is configured to a plurality hanging elements, wherein the plurality of hanging elements is configured to be suspended from a support;
wherein the hanging elements comprises inner notch and cut out for secure hold and preventing slippage from the support;
wherein each of the clamping arms includes a griping portion configured to securely grip the articles.

2. The hanging system as claimed in claim 1, wherein both the clamping arms comprises the suspension portion.

3. The hanging system as claimed in claim 1, wherein the support comprises a wire, a rod, a hanger bar, or similar structure for hanging the articles.

4. The hanging system as claimed in claim 1, wherein the plurality of hanging elements comprises a hook element with a semi-circular or U-shaped hanging element to hang the articles at multi-direction with the support.

5. The hanging system as claimed in claim 1, wherein the plurality of hanging elements includes a magnet.

6. The hanging system as claimed in claim 1, wherein the hanging element comprises a plurality of curvatures along the hook portion to provide multidirectional hanging with the support.

7. The hanging system as claimed in claim 1, wherein the plurality of the curvatures are further reinforced in the suspension portions to enhance load-bearing capacity and durability of the suspension portion.

8. The hanging system as claimed in claim 1, wherein the griping portion comprises oppositely placed elongated element.

9. The hanging system as claimed in claim 1, wherein an interlocking mechanism is designed to apply pressure and securely hold the article when elongated elements are compressed together.

10. The hanging system as claimed in claim 1, wherein the two clamping arms are oppositely placed and pivotally connected by a spring-loaded mechanism at a central portion, wherein the spring-loaded mechanism is configured to apply tension between the first clamping arm and the second clamping arm to maintain a closed position at a proximal end of the clamping arms.

11. The hanging system as claimed in claim 1, wherein the spring loaded mechanism comprises pin with rivets and spring assembly configured to provide tension and control, maintaining stability and secure attachment of the clamping arms.

12. A clip configured to securely hold at least an article, the clip comprising:
two clamping arms comprising a first clamping arm and a second clamping arm;
each of the clamping arm extends between a proximal end and a distal end;
wherein the two clamping arms are oppositely placed and pivotally connected;
wherein each of the clamping arms includes a griping portion configured to securely grip the articles;
wherein the griping portion comprises oppositely placed elongated element;
wherein an interlocking mechanism is designed between the gripping portion to apply pressure and securely hold the article when elongated elements are compressed together.

13. A multi-directional hanging device for a variety of articles, the multi-directional hanging device comprising:
a suspension portion configured to a plurality hanging elements, wherein the plurality of hanging elements is configured to suspend the multi-directional hanging device from a support;
wherein the plurality of hanging elements comprises a semi-circular or U-shaped hanging element;
wherein the plurality of hanging elements including curvatures aligned for muti directional hanging and enhanced load-bearing capacity.

14. The multi-directional hanging device as claimed in claim 13, wherein the suspension portion has an attachment.

15. The multi-directional hanging device as claimed in claim 14, wherein the attachment is configured to include a tool; a hanger; a hook; a clip; condiment container and dispenser; a peel and stick attachment for bars, coffee; a multidirectional cloth hanger; a Velcro strap attachment; book; packaging, and any article to be hanged.

16. The multi-directional hanging device as claimed in claim 13, wherein the attachment is permanent or removable.

17. The multi-directional hanging device as claimed in claim 13, wherein the support includes a wire, a rod, book organizer, scheduler, a magnetic rod attached for vehicle, kitchen, fridge, a hanger bar or any structure for hanging the articles.

18. The multi-directional hanging device as claimed in claim 13, wherein the attachment comprises two clamping arms which are oppositely placed and pivotally connected to each other.

19. The multi-directional hanging device as claimed in claim 13, wherein the pivot comprises the spring-loaded mechanism comprises pin, rivets and spring assembly configured to provide tension and control, maintaining stability and secure attachment of the clamping arms.
